(19) United States
(12) Patent Application Publication
(10) Pub. No.: US 2023/0166353 A1
(43) Pub. Date: Jun. 1, 2023

(54) METHOD FOR OPERATING AND CONTROLLING A LASER DEVICE FOR ENGRAVING, MARKING, LETTERING AND/OR CUTTING A PREFERABLY FLAT WORKPIECE

(71) Applicant: Trotec Laser GmbH, Marchtrenk (AT)

(72) Inventor: Alexander JAUKER, Neuhofen an der Krems (AT)

(21) Appl. No.: 17/920,697

(22) PCT Filed: Mar. 16, 2021
(86) PCT No.: PCT/AT2021/060088

§ 371 Date: Oct. 21, 2022

(30) Foreign Application Priority Data
Apr. 24, 2020 (AT) A50354/2020

(51) Int. Cl. B23K 26/08; B23K 26/06; B23K 26/352; B23K 26/362; G05B 19/409

(52) U.S. Cl. CPC B23K 26/0869; B23K 26/0626; B23K 26/352; B23K 26/362; G05B 19/409

(57) ABSTRACT

The present disclosure relates to a method for creating a job from a central operator software for various laser types, in particular a laser plotter or a galvo marking laser, for engraving, marking, lettering and/or cutting a preferably flat workpiece, in which at least one beam source in the form of a laser is used in a housing of the laser device for processing the workpiece. The workpiece is deposited in a defined manner in a processing chamber on a processing table and a laser beam emitted by the beam source is sent via deflecting elements to at least one focusing unit, by which the laser beam is deflected in the direction of the workpiece and positioned accordingly. The control is effected via control software running in a control unit, in which software a so-called job is processed.

This application is a U.S. National Stage filing of International Application No. PCT/AT2021/060088, filed Mar. 16, 2021, titled “METHOD FOR OPERATING AND CONTROLLING A LASER DEVICE FOR ENGRAVING, MARKING, INSCRIBING AND/OR CUTTING A PREFERABLY FLAT WORKPIECE”, which claims the benefit of priority to the Austrian Application No. A50354/2020, filed Apr. 24, 2020. All of the aforementioned applications are incorporated herein by reference in their entireties.

The present disclosure relates to a method for operating and controlling a laser device for engraving, marking, lettering and/or cutting a preferably flat workpiece, in which at least one beam source in the form of a laser is used in a housing of the laser device, wherein the workpiece is deposited in a defined manner on a processing table in the processing chamber of the housing and a laser beam emitted by the beam source and sent via deflecting elements to at least one focusing unit, from which the laser beam is deflected in the direction of the workpiece and focused for processing, wherein control, in particular the position control of the workpiece relative to the laser beam, is effected by means of control software which runs in a control unit and in which a so-called job is processed, so that the workpiece is processed preferably line by line by adjustment of a movement system, such as a carriage in the case of a laser plotter or an angular adjustment in the case of a galvo marking laser, as described in claim 1.

In laser devices, in particular laser plotters and galvo marking lasers, the laser light is guided from a laser source via deflecting elements to a focusing unit, wherein the laser beam is sharply focused by a focusing lens and deflected in the direction of the workpiece to be processed. Thus, in the focus of the laser beam an extremely high power density is produced, with which materials can be melted or evaporated, engraved, or lettered. The processing, in particular the engraving, is carried out line by line, for which various laser devices or systems, respectively, are used or employed, respectively.

On the one hand, a laser plotter is used in which the focusing unit is mounted on a carriage that is adjusted by a belt drive. The focusing unit is also arranged on the carriage so that it can be moved. Thus, by adjusting the carriage and the focusing unit, a processing chamber, in particular a processing table on which the workpiece is placed, can be completely processed.

On the other hand, gravo marking devices are known from the art whose focusing unit also has a focusing lens for bundling the laser beam, wherein the focusing unit is positioned centrally above the processing chamber. In order to be able to process the entire processing chamber with the bundled and focused laser beam, the gravo marking devices have an adjustable mirror in the focusing unit that can deflect the laser beam to any position in the defined processing chamber.

The main difference between these two device types, i.e. between a laser plotter and a gravo marking laser, is thus in the position or movement control, respectively, for the laser beam and the focusing unit.

The disadvantage is that for each device type a separate job must be created for processing the workpiece, in which the parameters, such as position or movement data, respectively, for creating a graphic or text, respectively, focus point, power, tool thickness, tool material, etc., must be created. I.e., if a graphic or text is to be engraved on several workpieces both on the laser plotter and with the gravo marking device, two different jobs, namely a laser plotter job and a gravo job, must be created for the processing, which are then loaded into the relevant device types.

For job creation, the graphics or texts, respectively, are usually created on suitable software, such as Corel Draw, Paint, etc., and then imported into the respective software for the laser plotter and/or the gravo marking laser, whereupon the further setting of the parameters, such as tool material, tool thickness, etc., must be set in the respective software, so that a job can then be generated, which is loaded into the respective laser type.

An objective of the present disclosure is to create a method and a laser plotter in which, on the one hand, the above-mentioned disadvantages are avoided and, on the other hand, user-friendliness is substantially increased.

The objective is achieved by the disclosed embodiments.

An objective of the present disclosure is achieved by a graphic and/or text being created or imported into a central operator software, whereupon in the central operator software for the creation of the job the parameters “material type, material thickness, engraving depth and effect (cutting through, engraving, deep engraving or similar)” are set, whereupon a laser type—laser plotter or galvo marking laser—is suggested or determined, respectively, by the operator software, or the desired laser type—laser plotter or galvo marking laser—is selected by the user, whereupon, after selection of the laser type, the movement parameters of the selected laser type required for generation of the graphics and/or text are determined or calculated, respectively, and defined by an analysis tool, whereupon the laser power and speed are calculated and defined by the analysis tool.

The advantage here is that the user only has to use one software for the individual laser types, so that errors, in particular setup errors, due to different operator functions with different software are prevented. Another significant advantage lies in user-friendliness, since the user needs to set only the minimum settings, such as material, workpiece thickness, engraving depth and, if necessary, the desired laser type and alternatively also lens type, whereupon all the required information or data, respectively, is generated.

It is also possible for the user to activate both laser types, whereby a separate job is created for each laser type. This means that the user only needs to make the basic settings once, after which the central operator software determines and calculates the other missing data or parameters, respectively, after which a corresponding job is created for further processing. It is also possible that, based on the selected laser or lens, a certain effect that can be achieved with the available components is suggested, i.e. that the customer selects, for example, a special laser and, based on the configuration or equipment, respectively, the best possible effect or several effects are suggested with the processing time, so that the customer can then select the effect necessary for him or her.

Another advantage is that an existing or older job can be opened or imported, respectively, from the central operating unit, so that the user can change the laser type, whereupon a new job is created for a different laser type, which is then loaded into the corresponding laser device. In the case of older jobs that were not created with the central operating unit, the central operating unit may display some query windows, such as “At which laser was the job used?” to the user, which the user must answer by entering or selecting predefined answers.

Advantageous embodiments are such that take into account the differing beam diameters of the laser types in the analysis tool for defining the movement parameters. This prevents a certain section of the workpiece being processed twice if the diameter of the laser beam is thicker and the paths of movement are too close, whereby the engraving depth on the workpiece in this area would be significantly altered. This is necessary because, due to different lenses in the two device types, i.e. in the laser plotter and in the galvo marking laser, laser dots of different widths are formed, so that overlapping can occur if the paths are too narrow, if this were not corrected in the analysis tool.

Advantageous embodiments are such in which, when the laser type “Laser plotter” is selected, the analysis tool determines and generates the movement parameters for x-y trajectories of a carriage. If necessary, the analysis tool also determines the table height, which can also be changed during the process if necessary.

However, advantageous embodiments are such in which the movement parameters for an angular adjustment of a mirror are determined and generated by the analysis tool when the laser type “Galvo marking laser” is selected. Concomitantly, the focus of the laser beam is determined and defined, since the focus point also changes due to the changes in the length of the laser beam.

However, further advantageous embodiments are such in which, depending on the laser type, a stored beam diameter, in particular laser spot diameter, is used for calculation of the movement parameters, or the lenses of the selected laser type are queried and the beam diameter is calculated or determined from a database according to the lens used. This ensures that the quality of the processing can be adjusted. This also prevents areas on the workpiece from being irradiated or processed, respectively, multiple times due to overlapping focal points.

Advantageous embodiments are such in which one or more setting options are selected in the “Effects” parameter, such as cut-through, engraving quality, in particular engraving low quality (300 dpi) or fine-detail engraving (600 dpi) or high-contrast engraving or photo engraving, deep engraving, fast cutting, precise cutting, etc. This allows the user to easily select from among various quality settings. Preferably, the required processing time is displayed to the user, so that he/she can easily see how long the processing will take when the quality is increased. It is therefore possible for the user to reduce the quality of urgently needed workpieces and thus reduce the processing time.

However, advantageous embodiments are also such where, upon activation of the “Laser type” parameter, a window is opened showing all the available laser units. This enables the user to see which types of lasers are available for processing, and thus to select his/her preferred laser. Furthermore, this gives the user the possibility that the location of a certain laser type can be queried by simply tapping or activating it, respectively. This can be done internally, e.g. by specifying the department, the factory hall, etc., or externally by means of a geographical representation, in particular Google Maps, wherein a corresponding window is opened for this purpose. This allows the user to select the laser that is easiest for him/her to reach within the company or, in the case of external lasers, the laser that is closest to him/her.

Advantageous embodiments are such in which all the available laser units can be selected in the open window. This allows a very specific laser to be selected. The user can thus manually distribute the jobs easily among the available lasers. It is also possible that in each case only those devices are displayed that were selected during the setting, i.e. if laser plotters are selected, only laser plotters can be displayed and selected, whereas the existing gravo marking lasers are displayed inactive or are completely omitted. Of course it is also possible, however, that with selected laser type “laser plotter” the user selects a “gravo marking laser”, since this would e.g. just happen to be free, so that a suitable query appears whether the laser type is to be changed, whereupon upon confirmation of this query the analysis tool carries out a recalculation.

Advantageous embodiments are also such where additional information is displayed for the individual laser units, such as status, processing time, capacity utilization, etc. This allows the user to immediately see which laser is free or will be free next.

Further advantageous embodiments are such in which where instead of the parameter Laser type all available laser units can be displayed and selected. This ensures that special properties of a wide variety of lasers can be taken into account by the analysis tool for the creation of the job.

Further advantageous embodiments are such in which the central operator software is invoked via a higher-level network, in particular in a cloud, wherein the available laser types, in particular laser units, are also connected or being connected, respectively, to the cloud. This ensures that, on the one hand, the central operator software can be easily maintained and always kept up to date and, on the other hand, several users can work with the operator software simultaneously. This is advantageous in that a company operates several locations, so that the utilization of the individual lasers can be seen by all.

Advantageous embodiments are also such in which the job created by the central operator software for a wide variety of laser types is stored in the cloud. This ensures that the job can be easily downloaded for processing from various locations. For example, a wide variety of jobs can be created at a central location, whereupon they are processed by the production sites after completion.

Also advantageous are those embodiments where the job can be loaded and processed simultaneously by one or more laser plotters of the same and different locations. This makes it possible to produce larger quantities as quickly as possible by downloading the job several times on different laser units.

Advantageous embodiments are such in which when the job is changed on one laser plotter, these changes are made available to the further laser plotters processing this job, in particular displayed. This allows each user to see what changes were made where, and also to accept or reject them for himself/herself.

In another advantageous embodiment upon connection of a laser plotter to the web-based central operator software, all settings/parameters and location pertaining to that laser plotter are automatically uploaded and stored in a web-based database. This makes it possible that when this laser unit is selected, the operator software, in particular the analysis tool, can take into account the relevant data of the device. In particular, this is done in such a way that when the specific laser is selected, the uploaded properties are loaded and considered for the calculation. It is also possible that the properties are loaded directly from the laser connected online for job creation.

Finally, advantageous embodiments are those where when the job is downloaded from a laser plotter, the safety policies appropriate to the location are adapted. This allows the job to be downloaded worldwide, as safety policies are adjusted depending on the location download.

Described hereinafter are exemplary embodiments where attention is drawn to the fact that the present disclosure is not limited to the exemplary embodiments or solutions, respectively, represented and described.

The figures show:

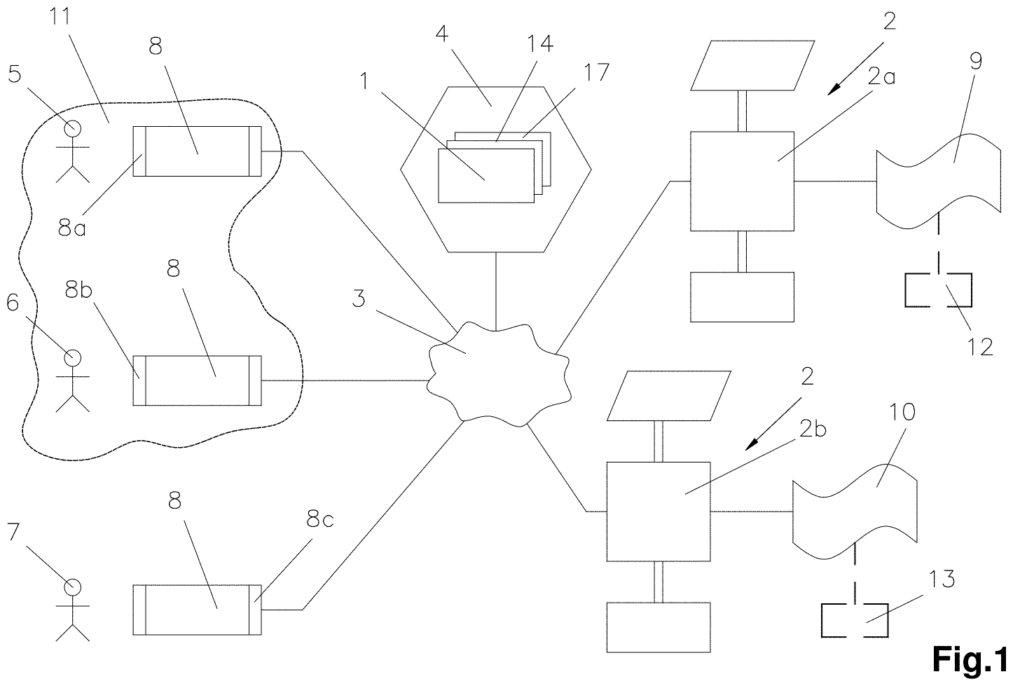

FIG. 1 a schematic illustration of the method for generating a job via a central operator software for various laser types or laser units, respectively, simplified, for illustrative purposes only;

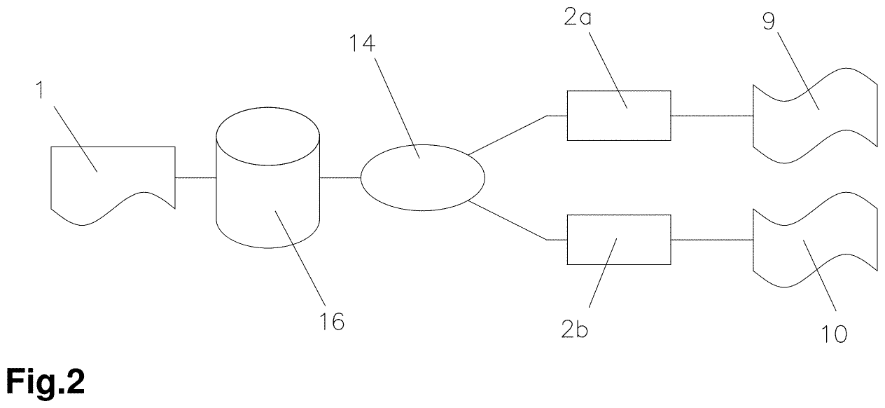

FIG. 2 a schematic illustration of a workflow for the creation of a job from a central operator software for various laser types, simplified, for illustrative purposes only;

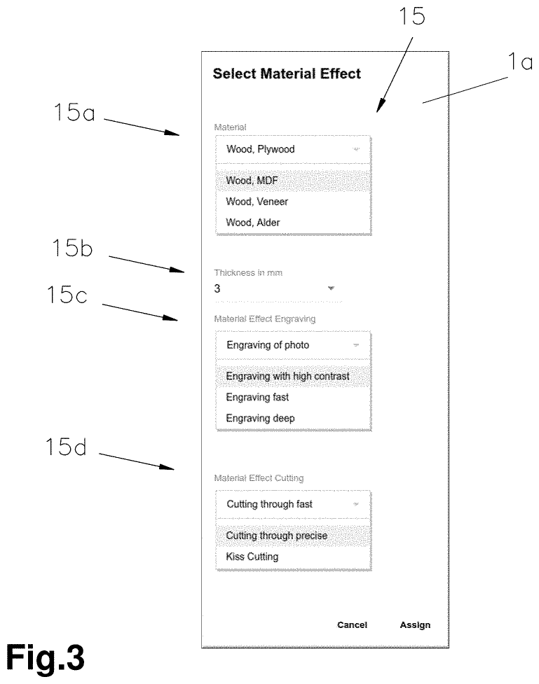

FIG. 3 a screenshot of the user interface, simplified, for illustrative purposes only;

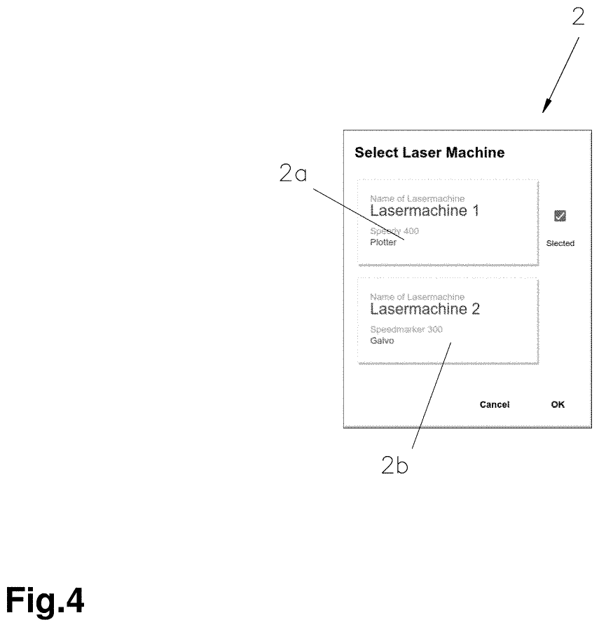

FIG. 4 a further screenshot of the user interface, simplified, for illustrative purposes only.

It should be stated by way of introduction that, in the individual embodiments, the same parts are provided with the same reference numbers or same component designations, respectively, wherein the disclosures contained in the entire description can, by analogy, be transferred to identical parts with identical reference numbers or identical component designations, respectively. The position details selected in the description, such as, e.g., top, bottom, lateral, etc., likewise relate to the figure described, and in the event of a change of position, they are to be transferred to the new position by analogy. Individual features or feature combinations from the exemplary embodiments shown and described may also represent independent inventive solutions.

In FIGS. 1 to 4 a process flow for a central operator software 1 is shown, which is used for various laser devices or laser units 2, respectively. Here, the operator software 1 is used on the one hand for so-called laser plotters 2a and on the other hand for so-called galvo marking lasers 2b.

I.e., a user creates and uses a job for processing a workpiece with the same operator software 1.

Preferably, the operator software 1 has a web-based structure, so that it is installed in a cloud 4 via the internet 3. In this case, a user 5,6,7 can access it via a web browser 8 by entering the address via the internet 3, so that the user interface of the operator software 1 is displayed in the browser 8 and corresponding input can be made to create a job 9,10 for a wide variety of laser units 2, in particular laser plotters 2a and/or galvo marking lasers 2b. Preferably, each user 5-7 has a personal login, so that a corresponding assignment can be made easily. Advantageously, several manufacturers or companies 11, respectively, can create a company login or company network 11, respectively, so that several users 5,6 of a company can individually or simultaneously access the central operator software 1 and thereby see all laser devices 2 or laser units 2, respectively, assigned to this company. In this case, company-related laser units 2 are not publicly visible, so that only users 5,6 of this company network who have the appropriate authorization can see and address these laser units 2 via the central operator software 1. It is of course possible for an authorized user 5,6, in particular an administrator 5, of the company network 11 to make one or more laser units 2 publicly accessible, so that corresponding jobs 9, 10 are also sent by external users 7 to these laser units 2 for a commissioned job.

As can now be seen from FIG. 1, a user 5-7 connects to the internet 3 and subsequently to the central operator software 1 in the cloud 4 via the browser 8, which can be opened on a laptop 8a, computer, tablet 8b or cell phone 8c, for example. Here, a user 5-7 enters an appropriate internet address, in particular a so-called IP address, so that a connection is established. The user interface of the central operator software 1 is then displayed in the browser 8. The user 5-7 can now use the operator software 1 normally, as if it were installed on his component, for example the laptop 8a, the computer, the tablet 8b, or the cell phone 8c.

To enable the users 5-7 to also to select the available laser units 2 via the central operator software 1, the laser units 2 are equipped with corresponding components, in particular a network card, so that by connecting a laser unit 2 to the internet 3, this laser unit 2 can be registered and configured in the cloud 4, in particular the central operator software 1. Thereby, the laser units 2 can be configured in such a way that they are publicly visible or visible only in the own company's network 11.

According to the present disclosure, it is now envisioned that all laser units 2 of different designs, i.e. all laser plotters 2a and galvo marking lasers 2b, are connected to the central operator software 1 and can also be selected. In this case, the operator software 1 creates both a job 9 for a laser plotter 2a and a job 10 for a galvo marking laser 2b, whereas in the prior art two different softwares are required for this purpose. This ensures that the user 5-7 needs to operate only one user interface to create a job 9,10 for one or both laser types.

For the sake of completeness, it is mentioned that in the laser units at least one beam source in the form of a laser is used in a housing, wherein a workpiece 12, 13 is deposited in a defined manner on a processing table in the processing chamber of the housing and a laser beam emitted by the beam source is sent via deflecting elements to at least one focusing unit, from which the laser beam is deflected in the direction of the workpiece and focused for processing. Control, in particular the position control of the workpiece with respect to the laser beam, is carried out by means of a control software running in a control unit in which the job 9 or 10 is processed, so that the workpiece is processed line by line by adjusting a movement system, such as a carriage in the case of a laser plotter 2a or an angular adjustment in the case of a galvo marking laser 2b. The two laser units 2 differ particularly in the motion control and the focusing lens used, in particular regarding the beam diameter.

These essential differences are thereby taken into account by an analysis tool 14 during the creation of the job 9,10.

For a job 9 and/or 10 now to be created, a user 5-7 must create or import only its diagram, respectively, and/or picture or the text and set some few parameters 15. For increased user-friendliness, the user 5-7 needs to enter only four parameters 15, namely:

15a Material of the workpiece

15b Thickness of the workpiece

15c Effect for engraving or engraving depth, respectively

15d Cutting effect;

as shown schematically in FIG. 3 by illustrating a screen interface of the operator software. Thus, even untrained employees or so-called laymen are enabled to make the setting of the parameters 15. For this purpose, the user 5-7 creates or imports a graphic and/or text in the central operator software 1, whereupon the parameters “material 15a, material thickness 15b, engraving depth or effect 15c, respectively, and cutting effect 15d” are set in the central operator software 1 for creation of the job 9 or 10. Subsequently, the operator software 1 suggests or determines, respectively, a laser type—laser plotter 2a or galvo marking laser 2b—or the user selects the desired laser type—laser plotter or galvo marking laser—as shown in FIG. 4 of an excerpt from the user interface 1a, whereupon, after selection of the laser type 2, the movement parameters of the selected laser type 2 required for the generation of the graphics and/or text are determined or calculated, respectively, and specified by the analysis tool 14, whereupon the laser power and speed are calculated and specified by the analysis tool 14 and the job 9 or 10 is created. Such a workflow is shown schematically in FIG. 2. Of course, it is possible for the user 5-7 to change any parameter 15.

It is possible for the operator software 1 and/or the analysis tool 14 to access a database 16, in particular a material database, in which further parameters 15 for processing a wide variety of materials are stored. Furthermore, other safety-relevant parameters 15 may be stored in this database 16, which are also taken into account by the analysis tool 14. For this purpose, machine-related data, such as lenses used, filter type, etc., are also stored, which are essential for the creation and selection of the laser unit 2. Of course, it is also possible for such machine-related data to be queried online directly by the analysis tool 14 from the respective laser units 2 via the internet connection. In particular, this is used whenever the user 5-7 selects a particular laser unit 2 that the analysis tool 14 accesses during creation and calculation of the job 9,10 and queries the relevant data. Among other things, the analysis tool 14 also takes into account the lenses used in the laser units 2 and the resulting beam diameters, i.e., if a laser unit 2 is selected and the resolution or quality, respectively, is too high and cannot be achieved by a beam diameter that is too thick, a message appears indicating that the selected quality cannot be achieved, or that another laser unit should be selected to achieve the quality.

Thus, it can be said that the customer or user 5-7, respectively, can perform all steps relevant to the creation of a workpiece 13,14 in the central web-based operator software 1, to which he or she can connect via a browser 8, wherein no additional software packages are required. By mapping a holistic system, work steps are optimized for each other, and interface inefficiencies completely eliminated. Laser population with process and work parameters is possible from a single point of contact, namely the cloud 4. Job data can be managed here and directly assigned to a respective laser or laser unit 2, respectively, and also started. For this purpose, a job database 17 can be populated directly, in which the created jobs 9, 10 for all laser units 2, i.e. for laser plotter 2a and galvo marking laser 2b, are stored. It is also possible to have order data transmitted via various attributes.

Thanks to the integration of the job database 17 in the cloud 4 or due to the storage possibility of the jobs 9,10 in the cloud 4, respectively, the job 9,10 for the workpiece processing can be downloaded by the web-based database 17 or cloud 4, respectively, directly from the laser device or the laser unit 2, respectively, wherein before the start of the download or during the download, the location of the laser device 2 or of the laser unit 2, respectively, is determined or queried, respectively, whereupon the applicable policies of the safety settings and, if necessary, further settings or parameters, respectively, for the determined location, in particular the country or region, respectively, are determined and the associated parameters, in particular so-called safety parameters, are checked in the job 9,10 and, if necessary, adjusted, i.e., that the jobs 9, 10 in the job database 17 are assigned to the individual laser units 2, which are successively processed, wherein these are adapted according to the processing location to the policies prescribed there. Thus, an automatic or manual download of the job 9,10 can be performed, and the user 5-7 does not have to make any further adaptations.

Preferably, the jobs 9,10 are downloaded manually since the operator of the laser unit 2 usually has to insert the workpiece 12,13 into the processing chamber of the laser unit 2. However, if the laser 2 has an automatic feeding device and an automatic removal device, the laser can independently load and process the jobs 9,10 assigned to it.

This enables the customer or user 5-7, respectively, to prepare his/her files, i.e. the jobs 9,10, for the laser 2 anywhere in the world and then go to the device and retrieve them there and process them immediately. Automatic adaptation of the job 9,10 to site regulations ensures compliance with all machine safety policies.

This makes it possible for the first time for jobs 9,10 to be generated in the web-based software 1 or operator software 1, respectively, independently of the laser units 2 and location, and to be exchanged between all possible laser devices 2 or laser units 2, respectively, and locations without additional adjustments by the user 5-7, wherein whenever a laser type is changed, for example from a galvo marking laser 2b to a laser plotter 2a, a recalculation is performed by the analysis tool 14 to adjust the movement parameters. This is made possible by an open format of programming called “MIP”. This is a text-based command language for lasers 2, in which metadata (number of instructions, control of peripherals such as: extractions, etc.) +machine commands are included. Here, the exchange of jobs 9,10 between different types of machines, i.e., a laser plotter 2a and a gravo marking laser 2b, for the analysis tool 14 is based on the following aspects:

A central material database 16 (e.g. the cloud 4)

Absolute parameters and no percentages, as known from the prior art

A central exchange option of jobs 9, 10 via the cloud 4

An intelligence that transforms material parameters between devices 2

Standardization of the devices 2 to each other,

As well as the location for the policies.

Furthermore, it is possible for the customer or user 5-7, respectively, to import his/her own files, in particular self-created graphics or text or old jobs, into the central web-based operator software 1. During import into the laser software or operator software 1, respectively, the graphics or text are automatically prepared for the laser process in the best possible way and any defective areas are repaired with regard to the laser process without any further action on the part of the user 5-7. The user 5-7 does not need to prepare the files in a manual and time-consuming way.

In this process, imported files are checked for possible defective points by the operator software, in particular the analysis tool:

Incompletely closed contours on which the laser would stop unintentionally.

Unconnected elements

Intersections of geometries

Changes in directions of adjacent elements

Duplications of identical elements are reduced to a single entity

Sub-graphics are reduced to a single graphic.

This reduces the machine movement and cycle time significantly.

Thus, it can be said that a new usage is provided to the customer or user 5-7, respectively, which enables even untrained users 5-7 to use it immediately. Laser settings such as laser power or speed are abstracted to such an extent that no explicit basic technical understanding is required to use the laser machine 2. Users or customers, respectively, 5-7 only need to select the material to be processed, material thickness, effect (desired quality) and cutting effect to have all other parameters 15 determined by the analysis tool 14. For the convenience of the user 5-7, the effects 15c may comprise the following selection items: “Fine-detail engraving”, “High-contrast engraving”, “Photo engraving”, “Deep engraving”, “Fast cutting”, “Precise cutting”, “. . . ”. It is also possible to have colors or layers assigned to a desired material effect, as known from the prior art.

However, the cloud 4 is also used to operate and control a laser device 2 for engraving, marking, lettering and/or cutting a flat workpiece. In this case, the job 9,10 for the workpiece processing is downloaded from a web-based database 17 or cloud 4, respectively, directly by the laser device 2 or laser unit 1, respectively, in particular the laser plotter 2a and/or galvo marking laser 2b, wherein before the start of the download or during the download, the location of the laser is determined or queried, respectively, whereupon the applicable policies of the safety settings and, if necessary, further settings or parameters, respectively, for the determined location, in particular the country or region, respectively, are determined and the associated parameters, in particular so-called safety parameters, are checked in the job and, if necessary, adjusted, i.e., depending on the country or region, respectively, the downloaded job 9,10 is automatically adapted to the policies applicable there for processing the workpiece 12,13 by a laser, so that the user no longer has to make any adjustments. It has turned out advantageous that the determined policies for the various locations, in particular countries or regions, respectively, are stored in a web-based database 17 or in the cloud 4, respectively.

As a matter of form, it should finally be emphasized that, for the better understanding of the structure of the engraving workflow 1 and its components or constituent parts, respectively, the same have in part been represented not to scale and/or enlarged and/or reduced in size, and above all only schematically.

In addition, individual features or feature combinations from the various exemplary embodiments shown and described can inherently form independent inventive solutions or solutions according to the present disclosure.

1-16. (canceled)

17. A method for creating a job from a central operator software for various laser types, in particular a laser plotter or a galvo marking laser, for engraving, marking, lettering and/or cutting of a flat workpiece, in which at least one beam source in the form of a laser is used in a housing of the laser device for processing the workpiece, wherein the workpiece is deposited in a defined manner in a processing chamber on a processing table, and a laser beam emitted by the beam source sent via deflecting elements to at least one focusing unit from which the laser beam is deflected in the direction of the workpiece and positioned accordingly, wherein control is effected by control software running in a control unit having a computer processor, in which the control software a so-called job is processed;
wherein a graphic and/or text is created or imported in central operator software, whereupon in the central operator software, for the purpose of creating the job the parameters “material, material thickness, engraving depth or effect, and cutting effect” are set, whereupon a laser type—the laser plotter or the galvo marking laser—is suggested or determined, by the central operator software, or the user selects the desired laser type—the laser plotter or galvo marking laser—, whereupon, after selection of the laser type, the movement parameters of the selected laser type required for the generation of the graphics and/or text are determined or calculated and fixed by an analysis tool, whereupon the laser power and speed are calculated and fixed by the analysis tool.

18. The method according to claim 17, wherein the individual beam diameters of the laser types are taken into account in the analysis tool for determining the movement parameters.

19. The method according to claim 17, wherein the movement parameters for x-y movement paths of a carriage are determined and generated by the analysis tool when the laser type “laser plotter” is selected.

20. The method according to claim 17, wherein the movement parameters for angular adjustment of a mirror are determined and generated by the analysis tool when the laser type “galvo marking laser” is selected.

21. The method according to claim 17, wherein, depending on the laser type, a stored beam diameter, in particular laser spot diameter, is used for calculation of the movement parameters, or the lenses of the selected laser type are interrogated and the beam diameter is calculated or determined from a database according to the lens used.

22. The method according to claim 17, wherein at parameter “Effects” one or more setting options, such as cut-through, engraving quality, in particular engraving at low quality or fine-detail engraving or high-contrast engraving or photo engraving, deep engraving, fast cutting, precise cutting, etc., are selected.

23. The method according to claim 17, wherein, when the parameter “Laser type” is activated, a window is opened in which all available laser units can be seen.

24. The method according to claim 23, wherein all the available laser units can be selected in the opened window.

25. The method according to claim 23, wherein additional information of the displayed laser units, such as status, processing time, utilization, etc., is displayed.

26. The method according to claim 17, wherein instead of the parameter “laser type”, all the available laser units can be displayed and selected.

27. The method according to claim 17, wherein the central operator software is invoked via a higher-level network, in particular in a cloud, wherein the available laser types, in particular laser units, are likewise connected or being connected, to the cloud.

28. The method according to claim 17, wherein the job is stored by the central operator software for a wide variety of laser types in the cloud.

29. The method according to claim 17, wherein the job can be loaded and processed simultaneously by one or more laser units, in particular laser plotters and/or gravo marking lasers, of the same and different locations.

30. The method according to claim 17, wherein, when the job is changed on a laser unit, in particular a laser plotter and/or gravo marking laser, these changes are made available to the further laser unit processing this job, in particular are displayed.

31. The method according to claim 17, wherein, when a laser unit is connected to the web-based central operator software, all settings/parameters and the location relating to this laser unit are automatically uploaded and stored in a web-based database.

32. The method according to claim 17, wherein, when downloading the job from a laser unit, in particular a laser plotter and/or gravo marking laser, the safety policies corresponding to the location are adapted.
